(19) United States
(12) Patent Application Publication
(10) Pub. No.: US 2024/0079761 A1
(43) Pub. Date: Mar. 7, 2024

(54) Impedance Transitions Between Boards for Antennas

(71) Applicant: Apple Inc., Cupertino, CA (US)

(72) Inventors: Jingni Zhong, Santa Clara, CA (US); Ming Chen, Cupertino, CA (US); Han Wang, Campbell, CA (US); Alden T Rush, San Diego, CA (US); Behnam Ghassemiparvin, San Jose, CA (US); Bhaskara R Rupakula, San Jose, CA (US); Yiren Wang, Cupertino, CA (US); Yuan Tao, Santa Clara, CA (US); Hao Xu, Cupertino, CA (US); Jennifer M Edwards, San Francisco, CA (US); Hongfei Hu, Cupertino, CA (US); Mattia Pascolini, San Francisco, CA (US)

(21) Appl. No.: 18/458,835

(22) Filed: Aug. 30, 2023

Related U.S. Application Data
(60) Provisional application No. 63/403,673, filed on Sep. 2, 2022.

(51) Int. Cl. H01Q 1/24; H01Q 1/48

(52) U.S. Cl. CPC H01Q 1/243; H01Q 1/48; H01Q 9/0407

(57) ABSTRACT

An electronic device may be provided with a flexible printed circuit and a rigid printed circuit mounted to the flexible printed circuit using a board-to-board (B2B) connector. The flexible printed circuit may include signal conductors coupled to one or more antennas on the rigid printed circuit through the B2B connector. A given one of the signal conductors may include a phase shifter segment on the flexible printed circuit and/or a thick impedance matching segment on the rigid printed circuit that help to form a smooth impedance transition from the flexible printed circuit to the rigid printed circuit and the antenna(s). The B2B connector may include signal contacts interleaved with a ground contacts. The B2B connector may include ground bars laterally surrounding the signal and ground contacts to maximize the strength of mechanical coupling between the flexible printed circuit and the rigid printed circuit.

This application claims the benefit of U.S. Provisional Patent Application No. 63/403,673, filed Sep. 2, 2022, which is hereby incorporated by reference herein in its entirety.

### BACKGROUND

This relates generally to electronic devices and, more particularly, to electronic devices with conductive paths for electrical components.

Electronic devices such as portable computers and cellular telephones are often provided with antennas. Transmission line paths are coupled to the antennas. The transmission line paths convey radio-frequency signals to or from the antennas.

It can be challenging to provide transmission line paths to antennas that are mechanically robust and that optimize wireless performance of the antennas.

### SUMMARY

An electronic device may be provided with a flexible printed circuit and a rigid printed circuit mounted to the flexible printed circuit using a radio-frequency board-to-board (B2B) connector. Transmission lines on the flexible printed circuit may be coupled to antenna resonating elements formed from segments of peripheral conductive housing structures. The flexible printed circuit may also include one or more transmission lines having signal conductors coupled to one or more antennas on the rigid printed circuit through the B2B connector.

A given one of the signal conductors may include a phase shifter segment on the flexible printed circuit and/or a thick impedance matching segment on the rigid printed circuit. The phase shifter segment and the thick impedance matching segment may help to form a smooth impedance transition from the flexible printed circuit to the rigid printed circuit and the antenna(s). The antenna(s) on the rigid printed circuit may convey ultra-wideband (UWB) signals or millimeter wave signals. The B2B connector may include one or more signal contacts interleaved with a set of ground contacts. Each signal contact may form part of a respective signal conductor for the antenna(s) on the rigid printed circuit. The B2B connector may include sets of ground bars laterally surrounding the signal contacts and ground contacts to maximize the strength of the mechanical coupling between the flexible printed circuit and the rigid printed circuit.

### BRIEF DESCRIPTION OF THE DRAWINGS

FIG. 1 is a perspective view of an illustrative electronic device in accordance with some embodiments.

FIG. 2 is a schematic diagram of illustrative circuitry in an electronic device in accordance with some embodiments.

FIG. 3 is a schematic diagram of illustrative wireless circuitry in accordance with some embodiments.

FIG. 4 is a cross-sectional side view of an electronic device having housing structures that may be used in forming antenna structures in accordance with some embodiments.

FIG. 5 is a top interior view of an illustrative electronic device having antennas at different locations in accordance with some embodiments.

FIG. 6 is rear view showing how an illustrative antenna on a rigid printed circuit board mounted to a flexible printed circuit may be fed by a signal conductor having impedance matching structures in accordance with some embodiments.

FIG. 7 is a cross-sectional side view showing how an illustrative signal conductor on a flexible printed circuit may include an impedance matching structure for an antenna on a rigid printed circuit board mounted to the flexible printed circuit in accordance with some embodiments.

FIG. 8 is a top view showing how an illustrative signal conductor on a flexible printed circuit may include an impedance matching structure that includes a phase shifting segment in accordance with some embodiments.

FIG. 9 is a plot of antenna performance (return loss) as a function of frequency showing how an illustrative phase shifting segment may optimize wireless performance of an antenna in accordance with some embodiments.

FIG. 10 is a cross-sectional side view showing how an illustrative signal conductor on a rigid printed circuit board may include an impedance matching structure for one or more antennas on the rigid printed circuit board in accordance with some embodiments.

FIG. 11 is a plot of antenna performance (return loss) as a function of frequency showing how an illustrative impedance matching structure on a rigid printed circuit board may optimize wireless performance of an antenna on the rigid printed circuit board in accordance with some embodiments.

FIGS. 12 and 13 show a top view of illustrative board-to-board connectors that may be used to couple a first portion of one or more signal conductors for one or more antennas on a rigid printed circuit board to a second portion of the one or more signal conductors on a flexible printed circuit in accordance with some embodiments.

### DETAILED DESCRIPTION

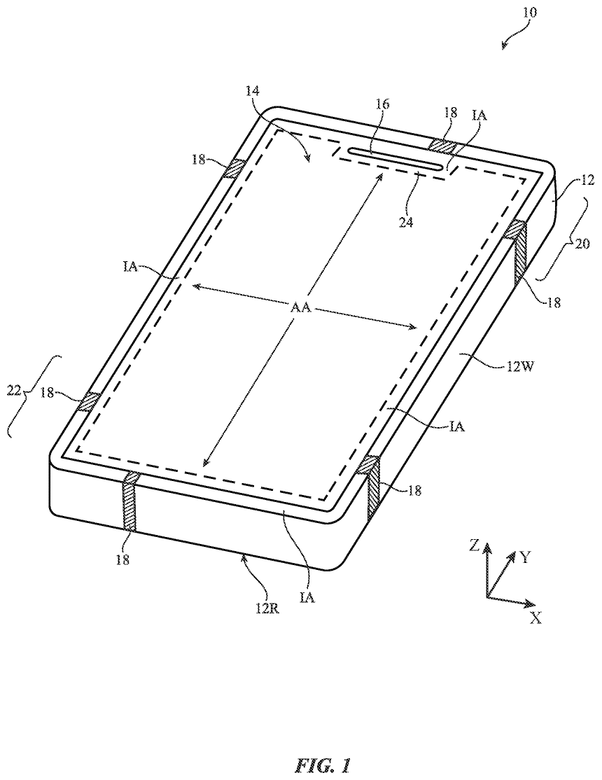

An electronic device such as electronic device 10 of FIG. 1 may be provided with wireless circuitry that includes antennas. The antennas may be used to transmit and/or receive wireless radio-frequency signals.

Device 10 may be a portable electronic device or other suitable electronic device. For example, device 10 may be a laptop computer, a tablet computer, a somewhat smaller device such as a wrist-watch device, pendant device, headphone device, earpiece device, headset device, or other wearable or miniature device, a handheld device such as a cellular telephone, a media player, or other small portable device. Device 10 may also be a set-top box, a desktop computer, a display into which a computer or other processing circuitry has been integrated, a display without an integrated computer, a wireless access point, a wireless base station, an electronic device incorporated into a kiosk, building, or vehicle, or other suitable electronic equipment.

Device 10 may include a housing such as housing 12. Housing 12, which may sometimes be referred to as a case, may be formed of plastic, glass, ceramics, fiber composites, metal (e.g., stainless steel, aluminum, etc.), other suitable materials, or a combination of these materials. In some situations, parts of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may, if desired, have a display such as display 14. Display 14 may be mounted on the front face of device 10. Display 14 may be a touch screen that incorporates capacitive touch electrodes or may be insensitive to touch. The rear face of housing 12 (i.e., the face of device 10 opposing the front face of device 10) may have a substantially planar housing wall such as rear housing wall 12R (e.g., a planar housing wall). Rear housing wall 12R may have slots that pass entirely through the rear housing wall and that therefore separate portions of housing 12 from each other. Rear housing wall 12R may include conductive portions and/or dielectric portions. If desired, rear housing wall 12R may include a planar metal layer covered by a thin layer or coating of dielectric such as glass, plastic, sapphire, or ceramic (e.g., a dielectric cover layer). Housing 12 may also have shallow grooves that do not pass entirely through housing 12. The slots and grooves may be filled with plastic or other dielectric materials. If desired, portions of housing 12 that have been separated from each other (e.g., by a through slot) may be joined by internal conductive structures (e.g., sheet metal or other metal members that bridge the slot).

Housing 12 may include peripheral housing structures such as peripheral structures 12W. Conductive portions of peripheral structures 12W and conductive portions of rear housing wall 12R may sometimes be referred to herein collectively as conductive structures of housing 12. Peripheral structures 12W may run around the periphery of device 10 and display 14. In configurations in which device 10 and display 14 have a rectangular shape with four edges, peripheral structures 12W may be implemented using peripheral housing structures that have a rectangular ring shape with four corresponding edges and that extend from rear housing wall 12R to the front face of device 10 (as an example). In other words, device 10 may have a length (e.g., measured parallel to the Y-axis), a width that is less than the length (e.g., measured parallel to the X-axis), and a height (e.g., measured parallel to the Z-axis) that is less than the width. Peripheral structures 12W or part of peripheral structures 12W may serve as a bezel for display 14 (e.g., a cosmetic trim that surrounds all four sides of display 14 and/or that helps hold display 14 to device 10) if desired. Peripheral structures 12W may, if desired, form sidewall structures for device 10 (e.g., by forming a metal band with vertical sidewalls, curved sidewalls, etc.).

Peripheral structures 12W may be formed from a conductive material such as metal and may therefore sometimes be referred to as peripheral conductive housing structures, conductive housing structures, peripheral metal structures, peripheral conductive sidewalls, peripheral conductive sidewall structures, conductive housing sidewalls, peripheral conductive housing sidewalls, sidewalls, sidewall structures, or a peripheral conductive housing member (as examples). Peripheral conductive housing structures 12W may be formed from a metal such as stainless steel, aluminum, alloys, or other suitable materials. One, two, or more than two separate structures may be used in forming peripheral conductive housing structures 12W.

It is not necessary for peripheral conductive housing structures 12W to have a uniform cross-section. For example, the top portion of peripheral conductive housing structures 12W may, if desired, have an inwardly protruding ledge that helps hold display 14 in place. The bottom portion of peripheral conductive housing structures 12W may also have an enlarged lip (e.g., in the plane of the rear surface of device 10). Peripheral conductive housing structures 12W may have substantially straight vertical sidewalls, may have sidewalls that are curved, or may have other suitable shapes. In some configurations (e.g., when peripheral conductive housing structures 12W serve as a bezel for display 14), peripheral conductive housing structures 12W may run around the lip of housing 12 (i.e., peripheral conductive housing structures 12W may cover only the edge of housing 12 that surrounds display 14 and not the rest of the sidewalls of housing 12).

Rear housing wall 12R may lie in a plane that is parallel to display 14. In configurations for device 10 in which some or all of rear housing wall 12R is formed from metal, it may be desirable to form parts of peripheral conductive housing structures 12W as integral portions of the housing structures forming rear housing wall 12R. For example, rear housing wall 12R of device 10 may include a planar metal structure and portions of peripheral conductive housing structures 12W on the sides of housing 12 may be formed as flat or curved vertically extending integral metal portions of the planar metal structure (e.g., housing structures 12R and 12W may be formed from a continuous piece of metal in a unibody configuration). Housing structures such as these may, if desired, be machined from a block of metal and/or may include multiple metal pieces that are assembled together to form housing 12. Rear housing wall 12R may have one or more, two or more, or three or more portions. Peripheral conductive housing structures 12W and/or conductive portions of rear housing wall 12R may form one or more exterior surfaces of device 10 (e.g., surfaces that are visible to a user of device 10) and/or may be implemented using internal structures that do not form exterior surfaces of device 10 (e.g., conductive housing structures that are not visible to a user of device 10 such as conductive structures that are covered with layers such as thin cosmetic layers, protective coatings, and/or other coating/cover layers that may include dielectric materials such as glass, ceramic, plastic, or other structures that form the exterior surfaces of device 10 and/or serve to hide peripheral conductive housing structures 12W and/or conductive portions of rear housing wall 12R from view of the user).

Display 14 may have an array of pixels that form an active area AA that displays images for a user of device 10. For example, active area AA may include an array of display pixels. The array of pixels may be formed from liquid crystal display (LCD) components, an array of electrophoretic pixels, an array of plasma display pixels, an array of organic light-emitting diode display pixels or other light-emitting diode pixels, an array of electrowetting display pixels, or display pixels based on other display technologies. If desired, active area AA may include touch sensors such as touch sensor capacitive electrodes, force sensors, or other sensors for gathering a user input.

Display 14 may have an inactive border region that runs along one or more of the edges of active area AA. Inactive area IA of display 14 may be free of pixels for displaying images and may overlap circuitry and other internal device structures in housing 12. To block these structures from view by a user of device 10, the underside of the display cover layer or other layers in display 14 that overlap inactive area IA may be coated with an opaque masking layer in inactive area IA. The opaque masking layer may have any suitable color. Inactive area IA may include a recessed region such as notch 24 that extends into active area AA. Active area AA may, for example, be defined by the lateral area of a display module for display 14 (e.g., a display module that includes pixel circuitry, touch sensor circuitry, etc.). The display module may have a recess or notch in upper region 20 of device 10 that is free from active display circuitry (i.e., that forms notch 24 of inactive area IA). Notch 24 may be a substantially rectangular region that is surrounded (defined) on three sides by active area AA and on a fourth side by peripheral conductive housing structures 12W. One or more sensors may be aligned with notch 24 and may transmit and/or receive light through display 14 within notch 24.

Display 14 may be protected using a display cover layer such as a layer of transparent glass, clear plastic, transparent ceramic, sapphire, or other transparent crystalline material, or other transparent layer(s). The display cover layer may have a planar shape, a convex curved profile, a shape with planar and curved portions, a layout that includes a planar main area surrounded on one or more edges with a portion that is bent out of the plane of the planar main area, or other suitable shapes. The display cover layer may cover the entire front face of device 10. In another suitable arrangement, the display cover layer may cover substantially all of the front face of device 10 or only a portion of the front face of device 10. Openings may be formed in the display cover layer. For example, an opening may be formed in the display cover layer to accommodate a button. An opening may also be formed in the display cover layer to accommodate ports such as speaker port 16 in notch 24 or a microphone port. Openings may be formed in housing 12 to form communications ports (e.g., an audio jack port, a digital data port, etc.) and/or audio ports for audio components such as a speaker and/or a microphone if desired.

Display 14 may include conductive structures such as an array of capacitive electrodes for a touch sensor, conductive lines for addressing pixels, driver circuits, etc. Housing 12 may include internal conductive structures such as metal frame members and a planar conductive housing member (sometimes referred to as a conductive support plate or backplate) that spans the walls of housing 12 (e.g., a substantially rectangular sheet formed from one or more metal parts that is welded or otherwise connected between opposing sides of peripheral conductive housing structures 12W). The conductive support plate may form an exterior rear surface of device 10 or may be covered by a dielectric cover layer such as a thin cosmetic layer, protective coating, and/or other coatings that may include dielectric materials such as glass, ceramic, plastic, or other structures that form the exterior surfaces of device 10 and/or serve to hide the conductive support plate from view of the user (e.g., the conductive support plate may form part of rear housing wall 12R). Device 10 may also include conductive structures such as printed circuit boards, components mounted on printed circuit boards, and other internal conductive structures. These conductive structures, which may be used in forming a ground plane in device 10, may extend under active area AA of display 14, for example.

In regions 22 and 20, openings may be formed within the conductive structures of device 10 (e.g., between peripheral conductive housing structures 12W and opposing conductive ground structures such as conductive portions of rear housing wall 12R, conductive traces on a printed circuit board, conductive electrical components in display 14, etc.). These openings, which may sometimes be referred to as gaps, may be filled with air, plastic, and/or other dielectrics and may be used in forming slot antenna resonating elements for one or more antennas in device 10, if desired.

Conductive housing structures and other conductive structures in device 10 may serve as a ground plane for the antennas in device 10. The openings in regions 22 and 20 may serve as slots in open or closed slot antennas, may serve as a central dielectric region that is surrounded by a conductive path of materials in a loop antenna, may serve as a space that separates an antenna resonating element such as a strip antenna resonating element or an inverted-F antenna resonating element from the ground plane, may contribute to the performance of a parasitic antenna resonating element, or may otherwise serve as part of antenna structures formed in regions 22 and 20. If desired, the ground plane that is under active area AA of display 14 and/or other metal structures in device 10 may have portions that extend into parts of the ends of device 10 (e.g., the ground may extend towards the dielectric-filled openings in regions 22 and 20), thereby narrowing the slots in regions 22 and 20. Region 22 may sometimes be referred to herein as lower region 22 or lower end 22 of device 10. Region 20 may sometimes be referred to herein as upper region 20 or upper end 20 of device 10.

In general, device 10 may include any suitable number of antennas (e.g., one or more, two or more, three or more, four or more, etc.). The antennas in device 10 may be located at opposing first and second ends of an elongated device housing (e.g., at lower region 22 and/or upper region 20 of device 10 of FIG. 1), along one or more edges of a device housing, in the center of a device housing, in other suitable locations, or in one or more of these locations. The arrangement of FIG. 1 is merely illustrative.

Portions of peripheral conductive housing structures 12W may be provided with peripheral gap structures. For example, peripheral conductive housing structures 12W may be provided with one or more dielectric-filled gaps such as gaps 18, as shown in FIG. 1. The gaps in peripheral conductive housing structures 12W may be filled with dielectric such as polymer, ceramic, glass, air, other dielectric materials, or combinations of these materials. Gaps 18 may divide peripheral conductive housing structures 12W into one or more peripheral conductive segments. The conductive segments that are formed in this way may form parts of antennas in device 10 if desired. Other dielectric openings may be formed in peripheral conductive housing structures 12W (e.g., dielectric openings other than gaps 18) and may serve as dielectric antenna windows for antennas mounted within the interior of device 10. Antennas within device 10 may be aligned with the dielectric antenna windows for conveying radio-frequency signals through peripheral conductive housing structures 12W. Antennas within device 10 may also be aligned with inactive area IA of display 14 for conveying radio-frequency signals through display 14.

To provide an end user of device 10 with as large of a display as possible (e.g., to maximize an area of the device used for displaying media, running applications, etc.), it may be desirable to increase the amount of area at the front face of device 10 that is covered by active area AA of display 14. Increasing the size of active area AA may reduce the size of inactive area IA within device 10. This may reduce the area behind display 14 that is available for antennas within device 10. For example, active area AA of display 14 may include conductive structures that serve to block radio-frequency signals handled by antennas mounted behind active area AA from radiating through the front face of device 10. It would therefore be desirable to be able to provide antennas that occupy a small amount of space within device 10 (e.g., to allow for as large of a display active area AA as possible) while still allowing the antennas to communicate with wireless equipment external to device 10 with satisfactory efficiency bandwidth.

In a typical scenario, device 10 may have one or more upper antennas and one or more lower antennas. An upper antenna may, for example, be formed in upper region 20 of device 10. A lower antenna may, for example, be formed in lower region 22 of device 10. Additional antennas may be formed along the edges of housing 12 extending between regions 20 and 22 if desired. The antennas may be used separately to cover identical communications bands, overlapping communications bands, or separate communications bands. The antennas may be used to implement an antenna diversity scheme or a multiple-input-multiple-output (MIMO) antenna scheme. Other antennas for covering any other desired frequencies may also be mounted at any desired locations within the interior of device 10. The example of FIG. 1 is merely illustrative. If desired, housing 12 may have other shapes (e.g., a square shape, cylindrical shape, spherical shape, combinations of these and/or different shapes, etc.).

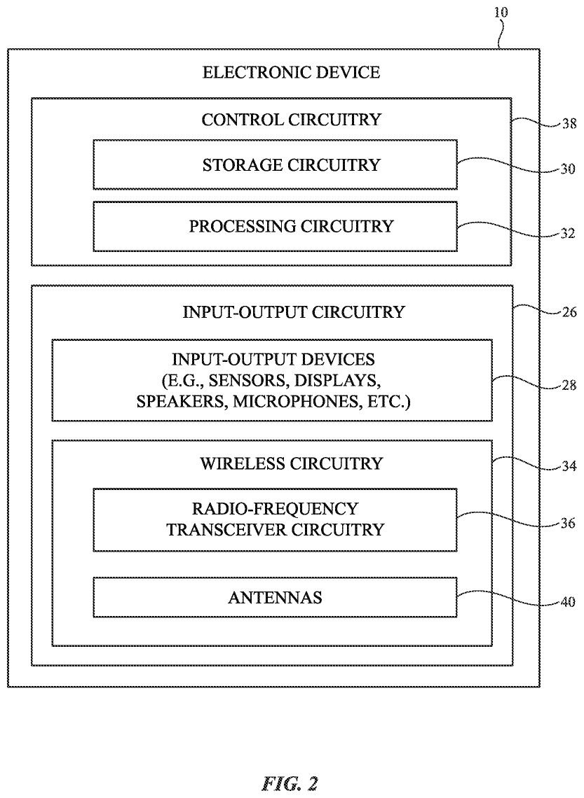

A schematic diagram of illustrative components that may be used in device 10 is shown in FIG. 2. As shown in FIG. 2, device 10 may include control circuitry 38. Control circuitry 38 may include storage such as storage circuitry 30. Storage circuitry 30 may include hard disk drive storage, nonvolatile memory (e.g., flash memory or other electrically-programmable-read-only memory configured to form a solid-state drive), volatile memory (e.g., static or dynamic random-access-memory), etc.

Control circuitry 38 may include processing circuitry such as processing circuitry 32. Processing circuitry 32 may be used to control the operation of device 10. Processing circuitry 32 may include one or more processors such as microprocessors, microcontrollers, digital signal processors, host processors, baseband processor integrated circuits, application specific integrated circuits, graphics processing units, central processing units (CPUs), etc. Control circuitry 38 may be configured to perform operations in device 10 using hardware (e.g., dedicated hardware or circuitry), firmware, and/or software. Software code for performing operations in device 10 may be stored on storage circuitry 30 (e.g., storage circuitry 30 may include non-transitory (tangible) computer readable storage media that stores the software code). The software code may sometimes be referred to as program instructions, software, data, instructions, or code. Software code stored on storage circuitry 30 may be executed by processing circuitry 32.

Control circuitry 38 may be used to run software on device 10 such as internet browsing applications, voice-over-internet-protocol (VOIP) telephone call applications, email applications, media playback applications, operating system functions, etc. To support interactions with external equipment, control circuitry 38 may be used in implementing communications protocols. Communications protocols that may be implemented using control circuitry 38 include internet protocols, wireless local area network protocols (e.g., IEEE 802.11 protocols—sometimes referred to as WiFi®), protocols for other short-range wireless communications links such as the Bluetooth® protocol or other WPAN protocols, IEEE 802.11ad protocols, cellular telephone protocols, MIMO protocols, antenna diversity protocols, satellite navigation system protocols, antenna-based spatial ranging protocols (e.g., radio detection and ranging (RADAR) protocols or other desired range detection protocols for signals conveyed at millimeter and centimeter wave frequencies), etc. Each communication protocol may be associated with a corresponding radio access technology (RAT) that specifies the physical connection methodology used in implementing the protocol.

Device 10 may include input-output circuitry 26. Input-output circuitry 26 may include input-output devices 28. Input-output devices 28 may be used to allow data to be supplied to device 10 and to allow data to be provided from device 10 to external devices. Input-output devices 28 may include user interface devices, data port devices, sensors, and other input-output components. For example, input-output devices 28 may include touch screens, displays without touch sensor capabilities, buttons, joysticks, scrolling wheels, touch pads, key pads, keyboards, microphones, cameras, speakers, status indicators, light sources, audio jacks and other audio port components, digital data port devices, light sensors, gyroscopes, accelerometers or other components that can detect motion and device orientation relative to the Earth, capacitance sensors, proximity sensors (e.g., a capacitive proximity sensor and/or an infrared proximity sensor), magnetic sensors, and other sensors and input-output components. The sensors in input-output devices 28 may include front-facing sensors that gather sensor data through display 14. The front-facing sensors may be optical sensors. The optical sensors may include an image sensor (e.g., a front-facing camera), an infrared sensor, and/or an ambient light sensor. The infrared sensor may include one or more infrared emitters (e.g., a dot projector and a flood illuminator) and/or one or more infrared image sensors.

Input-output circuitry 26 may include wireless circuitry such as wireless circuitry 34 for wirelessly conveying radio-frequency signals. While control circuitry 38 is shown separately from wireless circuitry 34 in the example of FIG. 2 for the sake of clarity, wireless circuitry 34 may include processing circuitry that forms a part of processing circuitry 32 and/or storage circuitry that forms a part of storage circuitry 30 of control circuitry 38 (e.g., portions of control circuitry 38 may be implemented on wireless circuitry 34). As an example, control circuitry 38 may include baseband processor circuitry or other control components that form a part of wireless circuitry 34.

Wireless circuitry 34 may include radio-frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

Wireless circuitry 34 may include radio-frequency transceiver circuitry 36 for handling transmission and/or reception of radio-frequency signals within corresponding frequency bands at radio frequencies (sometimes referred to herein as communications bands or simply as “bands”). The frequency bands handled by radio-frequency transceiver circuitry 36 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone communications bands such as a cellular low band (LB) (e.g., 600 to 960 MHz), a cellular low-midband (LMB) (e.g., 1400 to 1550 MHz), a cellular midband (MB) (e.g., from 1700 to 2200 MHz), a cellular high band (HB) (e.g., from 2300 to 2700 MHz), a cellular ultra-high band (UHB) (e.g., from 3300 to 5000 MHz, or other cellular communications bands between about 600 MHz and about 5000 MHz), 3G bands, 4G LTE bands, 3GPP 5G New Radio Frequency Range 1 (FR1) bands below 10 GHz, 3GPP 5G New Radio (NR) Frequency Range 2 (FR2) bands between 20 and 60 GHz, other centimeter or millimeter wave frequency bands between 10-300 GHz, near-field communications frequency bands (e.g., at 13.56 MHz), satellite navigation frequency bands such as the Global Positioning System (GPS) L1 band (e.g., at 1575 MHz), L2 band (e.g., at 1228 MHz), L3 band (e.g., at 1381 MHz), L4 band (e.g., at 1380 MHz), and/or L5 band (e.g., at 1176 MHz), a Global Navigation Satellite System (GLONASS) band, a BeiDou Navigation Satellite System (BDS) band, ultra-wideband (UWB) frequency bands that operate under the IEEE 802.15.4 protocol and/or other ultra-wideband communications protocols (e.g., a first UWB communications band at 6.5 GHz and/or a second UWB communications band at 8.0 GHz), communications bands under the family of 3GPP wireless communications standards, communications bands under the IEEE 802.XX family of standards, satellite communications bands such as an L-band, S-band (e.g., from 2-4 GHz), C-band (e.g., from 4-8 GHz), X-band, Ku-band (e.g., from 12-18 GHz), Ka-band (e.g., from 26-40 GHz), etc., industrial, scientific, and medical (ISM) bands such as an ISM band between around 900 MHz and 950 MHz or other ISM bands below or above 1 GHz, one or more unlicensed bands, one or more bands reserved for emergency and/or public services, and/or any other desired frequency bands of interest. Wireless circuitry 34 may also be used to perform spatial ranging operations if desired.

The UWB communications handled by radio-frequency transceiver circuitry 36 may be based on an impulse radio signaling scheme that uses band-limited data pulses. Radio-frequency signals in the UWB frequency band may have any desired bandwidths such as bandwidths between 499 MHz and 1331 MHz, bandwidths greater than 500 MHz, etc. The presence of lower frequencies in the baseband may sometimes allow ultra-wideband signals to penetrate through objects such as walls. In an IEEE 802.15.4 system, for example, a pair of electronic devices may exchange wireless time stamped messages. Time stamps in the messages may be analyzed to determine the time of flight of the messages and thereby determine the distance (range) between the devices and/or an angle between the devices (e.g., an angle of arrival of incoming radio-frequency signals).

Radio-frequency transceiver circuitry 36 may include respective transceivers (e.g., transceiver integrated circuits or chips) that handle each of these frequency bands or any desired number of transceivers that handle two or more of these frequency bands. In scenarios where different transceivers are coupled to the same antenna, filter circuitry (e.g., duplexer circuitry, diplexer circuitry, low pass filter circuitry, high pass filter circuitry, band pass filter circuitry, band stop filter circuitry, etc.), switching circuitry, multiplexing circuitry, or any other desired circuitry may be used to isolate radio-frequency signals conveyed by each transceiver over the same antenna (e.g., filtering circuitry or multiplexing circuitry may be interposed on a radio-frequency transmission line shared by the transceivers). Radio-frequency transceiver circuitry 36 may include one or more integrated circuits (chips), integrated circuit packages (e.g., multiple integrated circuits mounted on a common printed circuit in a system-in-package device, one or more integrated circuits mounted on different substrates, etc.), power amplifier circuitry, up-conversion circuitry, down-conversion circuitry, low-noise input amplifiers, passive radio-frequency components, switching circuitry, transmission line structures, and other circuitry for handling radio-frequency signals and/or for converting signals between radio-frequencies, intermediate frequencies, and/or baseband frequencies.

In general, radio-frequency transceiver circuitry 36 may cover (handle) any desired frequency bands of interest. As shown in FIG. 2, wireless circuitry 34 may include antennas 40. Radio-frequency transceiver circuitry 36 may convey radio-frequency signals using one or more antennas 40 (e.g., antennas 40 may convey the radio-frequency signals for the transceiver circuitry). The term “convey radio-frequency signals” as used herein means the transmission and/or reception of the radio-frequency signals (e.g., for performing unidirectional and/or bidirectional wireless communications with external wireless communications equipment). Antennas 40 may transmit the radio-frequency signals by radiating the radio-frequency signals into free space (or to freespace through intervening device structures such as a dielectric cover layer). Antennas 40 may additionally or alternatively receive the radio-frequency signals from free space (e.g., through intervening devices structures such as a dielectric cover layer). The transmission and reception of radio-frequency signals by antennas 40 each involve the excitation or resonance of antenna currents on an antenna resonating element in the antenna by the radio-frequency signals within the frequency band(s) of operation of the antenna.

Antennas 40 in wireless circuitry 34 may be formed using any suitable antenna structures. For example, antennas 40 may include antennas with resonating elements that are formed from stacked patch antenna structures, loop antenna structures, patch antenna structures, inverted-F antenna structures, slot antenna structures, planar inverted-F antenna structures, waveguide structures, monopole antenna structures, dipole antenna structures, helical antenna structures, Yagi (Yagi-Uda) antenna structures, hybrids of these designs, etc. If desired, antennas 40 may include antennas with dielectric resonating elements such as dielectric resonator antennas. If desired, one or more of antennas 40 may be cavity-backed antennas. Two or more antennas 40 may be arranged in a phased antenna array if desired (e.g., for conveying centimeter and/or millimeter wave signals within a signal beam formed in a desired beam pointing direction that may be steered/adjusted over time). Different types of antennas may be used for different bands and combinations of bands.

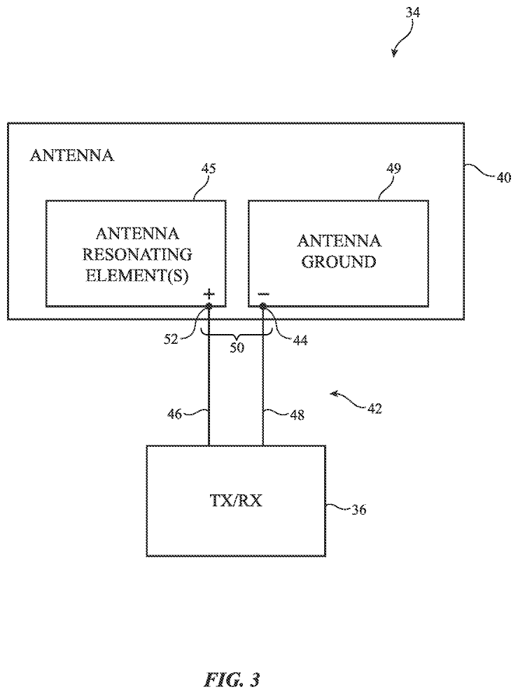

FIG. 3 is a schematic diagram showing how a given antenna 40 may be fed by radio-frequency transceiver circuitry 36. As shown in FIG. 3, antenna 40 may have a corresponding antenna feed 50. Antenna 40 may include one or more antenna resonating (radiating) elements 45 and an antenna ground 49. Antenna resonating element(s) 45 may include one or more radiating arms, slots, waveguides, dielectric resonators, patches, parasitic elements, indirect feed elements, and/or any other desired antenna radiators. Antenna feed 50 may include a positive antenna feed terminal 52 coupled to antenna resonating element 45 and a ground antenna feed terminal 44 coupled to antenna ground 49.

Radio-frequency transceiver (TX/RX) circuitry 36 may be coupled to antenna feed 50 using a radio-frequency transmission line path 42 (sometimes referred to herein as transmission line path 42). Transmission line path 42 may include a signal conductor such as signal conductor 46 (e.g., a positive signal conductor). Transmission line path 42 may include a ground conductor such as ground conductor 48. Ground conductor 48 may be coupled to ground antenna feed terminal 44 of antenna feed 50. Signal conductor 46 may be coupled to positive antenna feed terminal 52 of antenna feed 50.

Transmission line path 42 may include one or more radio-frequency transmission lines. The radio-frequency transmission line(s) in transmission line path 42 may include stripline transmission lines (sometimes referred to herein simply as striplines), coaxial cables, coaxial probes realized by metalized vias, microstrip transmission lines, edge-coupled microstrip transmission lines, edge-coupled stripline transmission lines, waveguide structures, combinations of these, etc. Multiple types of radio-frequency transmission line may be used to form transmission line path 42. Filter circuitry, switching circuitry, impedance matching circuitry, phase shifter circuitry, amplifier circuitry, and/or other circuitry may be interposed on transmission line path 42, if desired. One or more antenna tuning components for adjusting the frequency response of antenna 40 in one or more bands may be interposed on transmission line path 42 and/or may be integrated within antenna 40 (e.g., coupled between the antenna ground and the antenna resonating element of antenna 40, coupled between different portions of the antenna resonating element of antenna 40, etc.).

If desired, one or more of the radio-frequency transmission lines in transmission line path 42 may be integrated into ceramic substrates, rigid printed circuit boards, and/or flexible printed circuits. In one suitable arrangement, the radio-frequency transmission lines may be integrated within multilayer laminated structures (e.g., layers of a conductive material such as copper and a dielectric material such as a resin that are laminated together without intervening adhesive) that may be folded or bent in multiple dimensions (e.g., two or three dimensions) and that maintain a bent or folded shape after bending (e.g., the multilayer laminated structures may be folded into a particular three-dimensional shape to route around other device components and may be rigid enough to hold its shape after folding without being held in place by stiffeners or other structures). All the multiple layers of the laminated structures may be batch laminated together (e.g., in a single pressing process) without adhesive (e.g., as opposed to performing multiple pressing processes to laminate multiple layers together with adhesive).

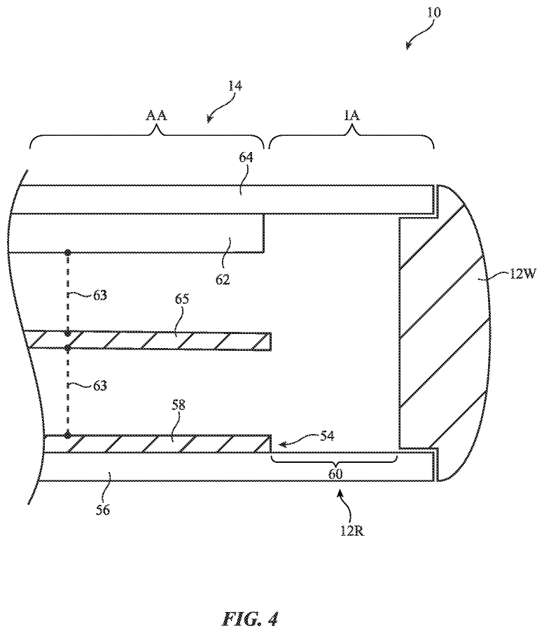

If desired, conductive electronic device structures such as conductive portions of housing 12 (FIG. 1) may be used to form at least part of one or more of the antennas 40 in device 10. FIG. 4 is a cross-sectional side view of device 10, showing illustrative conductive electronic device structures that may be used in forming one or more of the antennas 40 in device 10.

As shown in FIG. 4, peripheral conductive housing structures 12W may extend around the lateral periphery of device 10 (e.g., as measured in the X-Y plane of FIG. 1). Peripheral conductive housing structures 12W may extend from rear housing wall 12R (e.g., at the rear face of device 10) to display 14 (e.g., at the front face of device 10). In other words, peripheral conductive housing structures 12W may form conductive sidewalls for device 10, a first of which is shown in the cross-sectional side view of FIG. 4 (e.g., a given sidewall that runs along an edge of device 10 and that extends across the width or length of device 10).

Display 14 may have a display module such as display module 62 (sometimes referred to as a display panel). Display module 62 may include pixel circuitry, touch sensor circuitry, force sensor circuitry, and/or any other desired circuitry for forming active area AA of display 14. Display 14 may include a dielectric cover layer such as display cover layer 64 that overlaps display module 62. Display cover layer 64 may include plastic, glass, sapphire, ceramic, and/or any other desired dielectric materials. Display module 62 may emit image light and may receive sensor input (e.g., touch and/or force sensor input) through display cover layer 64. Display cover layer 64 and display 14 may be mounted to peripheral conductive housing structures 12W. The lateral area of display 14 that does not overlap display module 62 may form inactive area IA of display 14.

As shown in FIG. 4, rear housing wall 12R may be mounted to peripheral conductive housing structures 12W (e.g., opposite display 14). Rear housing wall 12R may include a conductive layer such as conductive support plate 58. Conductive support plate 58 may extend across an entirety of the width of device 10 (e.g., between the left and right edges of device 10 as shown in FIG. 1). Conductive support plate 58 may be formed from an integral portion of peripheral conductive housing structures 12W that extends across the width of device 10 or may include a separate housing structure attached, coupled, or affixed to peripheral conductive housing structures 12W.

If desired, rear housing wall 12R may include a dielectric cover layer such as dielectric cover layer 56. Dielectric cover layer 56 may include glass, plastic, sapphire, ceramic, one or more dielectric coatings, or other dielectric materials. Dielectric cover layer 56 may be layered under conductive support plate 58 (e.g., conductive support plate 58 may be coupled to an interior surface of dielectric cover layer 56). If desired, dielectric cover layer 56 may extend across an entirety of the width of device 10 and/or an entirety of the length of device 10. Dielectric cover layer 56 may overlap slot 60. If desired, dielectric cover layer 56 be provided with pigmentation and/or an opaque masking layer (e.g., an ink layer) that helps to hide the interior of device 10 from view. In another suitable arrangement, dielectric cover layer 56 may be omitted and slot 60 may be filled with a solid dielectric material.

The housing for device 10 may also include one or more additional conductive support plates interposed between display 14 and rear housing wall 12R. For example, the housing for device 10 may include a conductive support plate such as mid-chassis 65 (sometimes referred to herein as conductive support plate 65). Mid-chassis 65 may be vertically interposed between rear housing wall 12R and display 14 (e.g., conductive support plate 58 may be located at a first distance from display 14 whereas mid-chassis 65 is located at a second distance that is less than the first distance from display 14). Mid-chassis 65 may extend across an entirety of the width of device 10 (e.g., between the left and right edges of device 10 as shown in FIG. 1). Mid-chassis 65 may be formed from an integral portion of peripheral conductive housing structures 12W that extends across the width of device 10 or may include a separate housing structure attached, coupled, or affixed to peripheral conductive housing structures 12W. One or more components may be supported by mid-chassis 65 (e.g., logic boards such as a main logic board, a battery, etc.) and/or mid-chassis 65 may contribute to the mechanical strength of device 10. Mid-chassis 65 may be formed from metal (e.g., stainless steel, aluminum, etc.).

Conductive support plate 58, mid-chassis 65, and/or display module 62 may have an edge 54 that is separated from peripheral conductive housing structures 12W by dielectric-filled slot 60 (sometimes referred to herein as opening 60, gap 60, or aperture 60). Slot 60 may be filled with air, plastic, ceramic, or other dielectric materials. Conductive housing structures such as conductive support plate 58, mid-chassis 65, conductive portions of display module 62, and/or peripheral conductive housing structures 12W (e.g., the portion of peripheral conductive housing structures 12W opposite conductive support plate 58, mid-chassis 65, and display module 62 at slot 60) may be used to form antenna structures for one or more of the antennas 40 in device 10.

For example, peripheral conductive housing structures 12W may form an antenna resonating element arm (e.g., an inverted-F antenna resonating element arm) in the antenna resonating element 45 of an antenna 40 in device 10. Mid-chassis 65, conductive support plate 58, and/or display module 62 may be used to form the antenna ground 49 (FIG. 3) for one or more of the antennas 40 in device 10 and/or to form one or more edges of slot antenna resonating elements for the antennas in device 10. One or more conductive interconnect structures 63 may electrically couple mid-chassis 65 to conductive support plate 58 and/or one or more conductive interconnect structures 63 may electrically couple mid-chassis 65 to conductive structures in display module 62 (sometimes referred to herein as conductive display structures) so that each of these elements form part of the antenna ground. The conductive display structures may include a conductive frame, bracket, or support for display module 62, shielding layers in display module 62, ground traces in display module 62, etc.

Conductive interconnect structures 63 may serve to ground mid-chassis 65 to conductive support plate 58 and/or display module 62 (e.g., to ground conductive support plate 58 to the conductive display structures through mid-chassis 65). Put differently, conductive interconnect structures 63 may hold the conductive display structures, mid-chassis 65, and/or conductive support plate 58 to a common ground or reference potential (e.g., as a system ground for device 10 that is used to form part of antenna ground 49 of FIG. 3). Conductive interconnect structures 63 may therefore sometimes be referred to herein as grounding structures 63, grounding interconnect structures 63, or vertical grounding structures 63. Conductive interconnect structures 63 may include conductive traces, conductive pins, conductive springs, conductive prongs, conductive brackets, conductive screws, conductive clips, conductive tape, conductive wires, conductive traces, conductive foam, conductive adhesive, solder, welds, metal members (e.g., sheet metal members), contact pads, conductive vias, conductive portions of one or more components mounted to mid-chassis 65 and/or conductive support plate 58, and/or any other desired conductive interconnect structures.

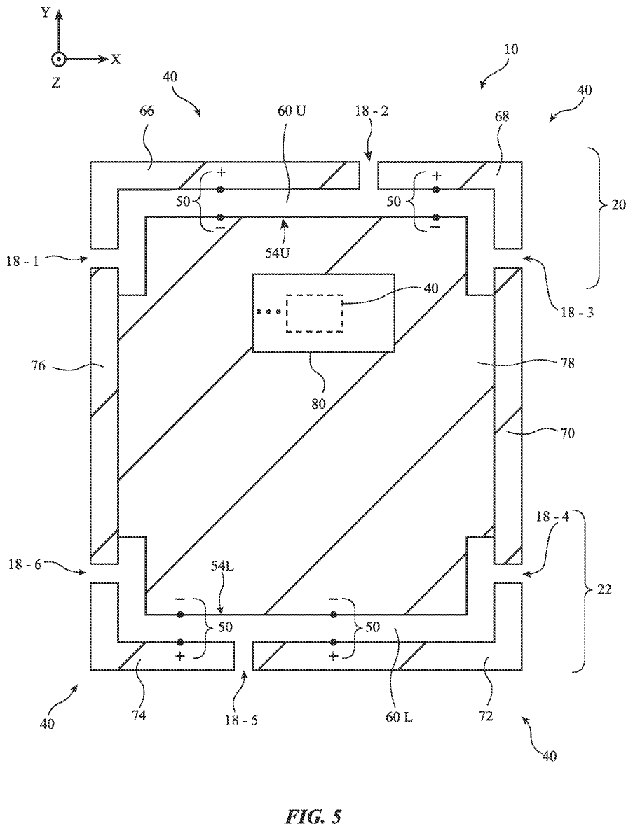

If desired, device 10 may include multiple slots 60 and peripheral conductive housing structures 12W may include multiple dielectric gaps that divide the peripheral conductive housing structures into segments (e.g., dielectric gaps 18 of FIG. 1). FIG. 5 is a top interior view showing how device 10 may include multiple slots 60 and may include multiple dielectric gaps that divide the peripheral conductive housing structures into segments. Display 14 and other internal components have been removed from the view shown in FIG. 5 for the sake of clarity.

As shown in FIG. 5, peripheral conductive housing structures 12W may include a first conductive sidewall at the left edge of device 10, a second conductive sidewall at the top edge of device 10, a third conductive sidewall at the right edge of device 10, and a fourth conductive sidewall at the bottom edge of device 10 (e.g., in an example where device 10 has a substantially rectangular lateral shape). Peripheral conductive housing structures 12W may be segmented by dielectric-filled gaps 18 such as a first gap 18-1, a second gap 18-2, a third gap 18-3, a fourth gap 18-4, a fifth gap 18-5, and a sixth gap 18-6. Gaps 18-1, 18-2, 18-3, 18-4, 18-5, and 18-6 may be filled with plastic, ceramic, sapphire, glass, epoxy, or other dielectric materials. The dielectric material in the gaps may lie flush with peripheral conductive housing structures 12W at the exterior surface of device 10 if desired.

Gap 18-1 may divide the first conductive sidewall to separate segment 76 of peripheral conductive housing structures 12W from segment 66 of peripheral conductive housing structures 12W. Gap 18-2 may divide the second conductive sidewall to separate segment 66 from segment 68 of peripheral conductive housing structures 12W. Gap 18-3 may divide the third conductive sidewall to separate segment 68 from segment 70 of peripheral conductive housing structures 12W. Gap 18-4 may divide the third conductive sidewall to separate segment 70 from segment 72 of peripheral conductive housing structures 12W. Gap 18-5 may divide the fourth conductive sidewall to separate segment 72 from segment 74 of peripheral conductive housing structures 12W. Gap 18-6 may divide the first conductive sidewall to separate segment 74 from segment 76.

In this example, segment 66 forms the top-left corner of device 10 (e.g., segment 66 may have a bend at the corner) and is formed from the first and second conductive sidewalls of peripheral conductive housing structures 12W (e.g., in upper region 20 of device 10). Segment 68 forms the top-right corner of device 10 (e.g., segment 68 may have a bend at the corner) and is formed from the second and third conductive sidewalls of peripheral conductive housing structures 12W (e.g., in upper region 20 of device 10). Segment 72 forms the bottom-right corner of device 10 and is formed from the third and fourth conductive sidewalls of peripheral conductive housing structures 12W (e.g., in lower region 22 of device 10). Segment 74 forms the bottom-left corner of device 10 and is formed from the fourth and first conductive sidewalls of peripheral conductive housing structures 12W (e.g., in lower region 22 of device 10).

Device 10 may include ground structures 78 (e.g., structures that form part of antenna ground 49 of FIG. 3 for one or more of the antennas 40 in device 10). Ground structures 78 may include one or more metal layers such conductive support plate 58 (FIG. 4), mid-chassis 65 (FIG. 4), conductive display structures in display module 62 (FIG. 4), conductive interconnect structures 63 (FIG. 4), conductive traces on a printed circuit board, conductive portions of one or more components in device 10, etc. Ground structures 78 may extend between opposing sidewalls of peripheral conductive housing structures 12W. For example, ground structures 79 may extend from segment 70 to segment 76 of peripheral conductive housing structures 12W (e.g., across the width of device 10, parallel to the X-axis of FIG. 5). Ground structures 78 may be welded or otherwise affixed to segments 76 and 70. In another suitable arrangement, some or all of ground structures 78, segment 76, and segment 70 may be formed from a single, integral (continuous) piece of machined metal (e.g., in a unibody configuration).

As shown in FIG. 5, device 10 may include multiple slots 60 (FIG. 4). For example, device 10 may include an upper slot such as slot 60U in upper region 20 and a lower slot such as slot 60L in lower region 22. The lower edge of slot 60U may be defined by upper edge 54U of ground structures 78. The upper edge of slot 60U may be defined by segments 66 and 68 (e.g., slot 60U may be interposed between ground structures 78 and segments 66 and 68 of peripheral conductive housing structures 12W). The upper edge of slot 60L may be defined by lower edge 54L of ground structures 78. The lower edge of slot 60L may be defined by segments 74 and 72 (e.g., slot 60L may be interposed between ground structures 78 and segments 74 and 72 of peripheral conductive housing structures 12W).

Slot 60U may have an elongated shape extending from a first end at gap 18-2 to an opposing second end at gap 18-3 (e.g., slot 60U may span the width of device 10). Similarly, slot 60L may have an elongated shape extending from a first end at gap 18-6 to an opposing second end at gap 18-4 (e.g., slot 60L may span the width of device 10). Slots 60U and 60L may be filled with air, plastic, glass, sapphire, epoxy, ceramic, or other dielectric material. Slot 60U may be continuous with gaps 18-1, 18-2, and 18-3 in peripheral conductive housing structures 12W if desired (e.g., a single piece of dielectric material may be used to fill both slot 60U and gaps 18-1, 18-2, and 18-3). Similarly, slot 60L may be continuous with gaps 18-6, 18-5, and 18-4 if desired (e.g., a single piece of dielectric material may be used to fill both slot 60L and gaps 18-6, 18-5, and 18-4).

Ground structures 78, segment 66, segment 68, and portions of slot 60U may be used in forming multiple antennas 40 in upper region 20 of device 10 (sometimes referred to herein as upper antennas). Ground structures 78, portions of slot 60L, segment 74, and segment 72 may be used in forming multiple antennas 40 in lower region 22 of device 10 (sometimes referred to herein as lower antennas). Each antenna 40 may be fed by a respective antenna feed 50. For example, a first antenna 40 in the upper-left corner of device 10 may have an antenna resonating element (e.g., an antenna arm) formed from segment 66 and a corresponding antenna feed 50 coupled between segment 66 and ground structures 78 across slot 60U (e.g., where the positive antenna feed terminal of the antenna feed is coupled to segment 66 and the ground antenna feed terminal of the antenna feed is coupled to ground structures 78). A second antenna 40 in the upper-right corner of device 10 may have an antenna resonating element (e.g., an antenna arm) formed from segment 68 and a corresponding antenna feed 50 coupled across slot 60L between segment 68 and ground structures 78 (e.g., where the positive antenna feed terminal of the antenna feed is coupled to segment 68 and the ground antenna feed terminal of the antenna feed is coupled to ground structures 78). A third antenna 40 in the bottom-right corner of device 10 may have an antenna resonating element (e.g., an antenna arm) formed from segment 72 and a corresponding antenna feed 50 coupled between segment 72 and ground structures 78 (e.g., where the positive antenna feed terminal of the antenna feed is coupled to segment 72 and the ground antenna feed terminal of the antenna feed is coupled to ground structures 78). A fourth antenna 40 in the bottom-left corner of device 10 may have an antenna resonating element (e.g., an antenna arm) formed from segment 74 and a corresponding antenna feed 50 coupled between segment 74 and ground structures 78 (e.g., where the positive antenna feed terminal of the antenna feed is coupled to segment 74 and the ground antenna feed terminal of the antenna feed is coupled to ground structures 78).

Ground structures 78 may include one or openings (e.g., slots, notches, apertures, or windows) such as opening 80. Opening 80 may, if desired, be laterally surrounded by ground structures 78 (e.g., in the X-Y plane). Device 10 may include one or more antennas 40 overlapping opening 80. The antenna(s) 40 may convey radio-frequency signals through opening 80 (e.g., through the rear housing wall or rear face of device 10 via opening 80 in ground structures 78). The antenna(s) 40 that radiate through opening 80 may, for example, include a single UWB antenna that conveys UWB signals in a first frequency band B1 (e.g., a UWB frequency band from 7750 MHz to 8250 MHz) through opening 80 and the rear housing wall and/or may include a set of millimeter wave antennas (e.g., a phased antenna array) that conveys millimeter/centimeter wave signals in a second frequency band B2 (e.g., a 5G NR FR2 band from 37 GHz to 43 GHz) through opening 80 and the rear housing wall.

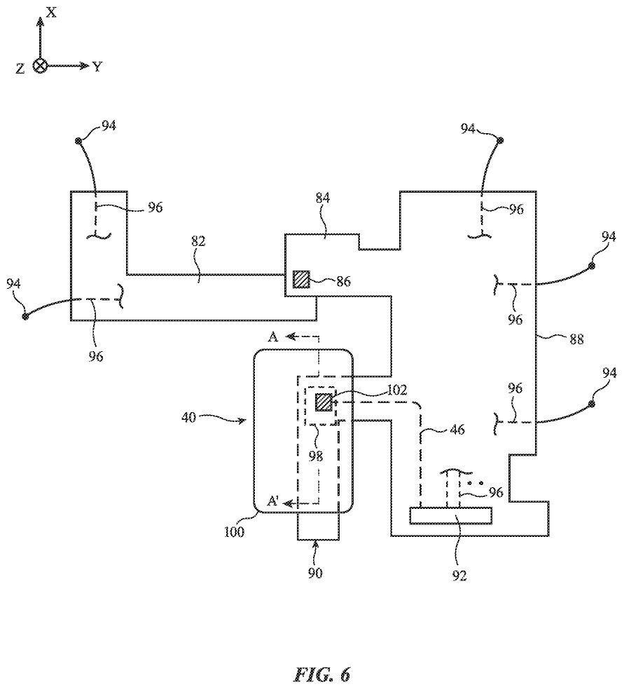

The antenna(s) 40 that radiate through opening 80 may be mounted to a first printed circuit. The first printed circuit may be mounted to a second printed circuit. The second printed circuit may be used to feed the other antennas 40 in device 10 (e.g., the antennas 40 having resonating elements formed from segments of peripheral conductive housing structures 12W). FIG. 6 is a rear view showing one example of how the antenna(s) 40 that radiate through opening 80 may be mounted to a first printed circuit that is mounted to a second printed circuit used to feed other antennas in device 10.

As shown in FIG. 6, one or more antennas 40 that radiate through opening 80 of FIG. 5 may be disposed on a first substrate such as printed circuit 100. Printed circuit 100 may be mounted to a second substrate such as printed circuit 88 (e.g., using a surface-mount technology (SMT) process). Printed circuit 100 may, for example, be mounted to printed circuit 88 by (using) a radio-frequency board-to-board (B2B) connector such as B2B connector 102. The antenna(s) 40 on printed circuit 100 may be aligned with opening 80 of FIG. 5. If desired, a third substrate such as printed circuit 82 may be mounted to printed circuit 88 (e.g., using an SMT process). Printed circuit 82 may, for example, be mounted to printed circuit 88 by a radio-frequency board-to-board (B2B) connector such as B2B connector 86. B2B connector 86 may include solder and conductive contact pads, for example.

Printed circuits 100, 88, and 82 may each include rigid printed circuit boards or flexible printed circuits. In one implementation that described herein as an example, printed circuit 100 is a rigid printed circuit board whereas printed circuits 88 and 82 are flexible printed circuits. If desired, printed circuit 88 may have a main body portion and may have a tail portion such as tail 90 extending from the main body portion. A radio-frequency connector 92 (e.g., a B2B connector) may be disposed on the main body portion of printed circuit 88. If desired, printed circuit 100 may be mounted to tail 90 of printed circuit 88. Radio-frequency connector 92 may be coupled to transceiver 42 (FIG. 3) if desired (e.g., on a different substrate in device 10).

As shown in FIG. 6, the signal conductor 46 for the transmission line path 42 (FIG. 3) for each antenna 40 on printed circuit 100 may extend from radio-frequency connector 92 and into tail 90 of printed circuit 88. The signal conductor(s) 46 may be coupled to B2B connector 102. While only a single signal conductor 46 is shown in FIG. 6 for the sake of clarity, there may be one or two signal conductors 46 coupled between radio-frequency connector 92 and B2B connector 102 for each antenna 40 on printed circuit 100 (e.g., for each antenna 40 that radiates through opening 80 of FIG. 5). Each signal conductor 46 may include conductive traces and/or one or more conductive vias in printed circuit 88 (e.g., coupled between radio-frequency connector 92 and B2B connector 102) as well as conductive traces and/or one or more conductive vias in printed circuit 100 (e.g., extending from B2B connector 102 to positive antenna feed terminal(s) on corresponding antenna(s) 40 in printed circuit 100).

Printed circuit 88 may also include other conductors 96 (e.g., signal conductors 46 and/or ground conductors 48 of FIG. 3) for radio-frequency transmission lines coupled to other antennas in device 10. Conductors 96 may include conductive traces and/or conductive vias. One or more conductors 96 may extend into printed circuit 82 through B2B connector 86. Conductors 96 may extend from radio-frequency connector 92 to one or more conductive interconnect structures 94 on printed circuit 88 and/or printed circuit 82 (e.g., three conductive interconnect structures 94 on printed circuit 88 and two conductive interconnect structures 94 on printed circuit 82).

Each conductive interconnect structure 94 may be coupled to peripheral conductive housing structures 12W of FIG. 5 (e.g., to the antenna resonating element 45 (FIG. 3) of one or more of the antennas 40 formed from peripheral conductive housing structures 12W (as shown in FIG. 5). Each conductive interconnect structure 94 may, for example, be coupled to a positive antenna feed terminal of the antenna(s) or may form part of a return path for the antenna(s). Conductive interconnect structures 94 may include conductive traces, conductive pins, conductive springs, conductive prongs, conductive brackets, conductive screws, conductive clips, conductive tape, conductive wires, conductive foam, conductive adhesive, solder, welds, metal members (e.g., sheet metal members), contact pads, conductive vias, and/or any other desired conductive interconnect structures. Conductive interconnect structures 94 may also serve to attach, affix, secure, or mount printed circuits 82, 88, and 100 to peripheral conductive housing structures 12W.

If care is not taken, the radio-frequency transition along signal conductor 46 from printed circuit 88 to printed circuit 100 (at B2B connector 102) can exhibit undesirable impedance discontinuities. The impedance discontinuities can cause unwanted radio-frequency signal reflection at B2B connector 102 that minimizes the overall antenna efficiency of the antenna(s) 40 on printed circuit 100. Impedance matching structures 98 may therefore be used to form a smooth radio-frequency impedance transition between printed circuits 88 and 100 (at B2B connector 102). In some implementations, the impedance matching structures include discrete impedance matching components (e.g., surface mount capacitors and inductors coupled to signal conductor that). However, discrete matching components may exhibit insufficient tolerance and can consume an excessive amount of real estate on printed circuit 88 and/or printed circuit 100. To mitigate these issues, impedance matching structures 98 may be formed from one or more integral segments of signal conductor 46 itself (e.g., signal conductor 46 may form or include impedance matching structures 98). Impedance matching structures 98 may be located on a first portion of signal conductor 46 on printed circuit 88, a second portion of signal conductor 46 on printed circuit 100, and/or within B2B connector 102.

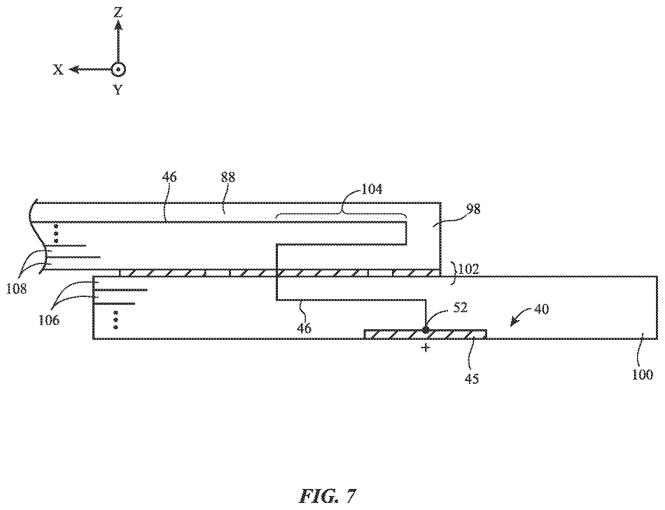

FIG. 7 is a cross-sectional side view of printed circuit 88 and printed circuit 100 at B2B connector 102 showing one example of how a first portion of signal conductor 46 on printed circuit 88 may include impedance matching structures 98 (e.g., as taken along line AA′ of FIG. 6). As shown in FIG. 7, printed circuit 88 may include one or more stacked dielectric layers 108 of printed circuit material (e.g., flexible printed circuit board material such as liquid crystal polymer (LCP) or polyimide). Printed circuit 100 may also include one or more stacked dielectric layers 106 of printed circuit material (e.g., rigid printed circuit board material such as ceramic, cured epoxy resin, fiberglass, combinations of these and/or other rigid materials, etc.).

One of the dielectric layers 108 of printed circuit 88 may be surface-mounted to one of the dielectric layers 106 of printed circuit 100 at (using) B2B connector 102. B2B connector 102 may include conductive contacts formed from solder and conductive contact pads on printed circuit 88 and/or printed circuit 100. One or more antennas 40 may be integrated into printed circuit 100. For example, each antenna 40 may include an antenna resonating element 45 formed from conductive traces on one or more dielectric layers 106 (e.g., an outermost dielectric layer 106) of printed circuit 100 (e.g., patch element(s) on printed circuit 100). In one implementation that is described herein as an example, printed circuit 100 of FIG. 7 may include a single antenna 40 that conveys UWB signals through opening 80 in ground structures 78 (FIG. 5).

Signal conductor 46 may extend from printed circuit 88 (e.g., radio-frequency connector 92 of FIG. 6) to B2B connector 102 and through printed circuit 100 to positive antenna feed terminal 52 on antenna resonating element 45. Signal conductor 46 may have a first portion disposed on printed circuit 88 and coupled to B2B connector 102 (e.g., a signal contact in B2B connector 102). The first portion of signal conductor 46 may include, for example, conductive traces on one or more dielectric layers 108 and/or conductive vias extending through one or more dielectric layers 108 of printed circuit 88. Signal conductor 46 may have a second portion disposed on printed circuit 100 and coupled between positive antenna feed terminal 52 and B2B connector 102 (e.g., the signal contact in B2B connector 102). The second portion of signal conductor 46 may include, for example, conductive traces on one or more dielectric layers 106 and/or conductive vias extending through one or more dielectric layers 106 of printed circuit 100.

As shown in FIG. 7, the first portion of signal conductor 46 on printed circuit 88 may include impedance matching structures 98. Impedance matching structures 98 may include a phase shifter segment 104 at or adjacent to B2B connector 102 (sometimes referred to herein as phase shifting segment 104). Phase shifter segment 104 may have a first end (terminal) coupled to radio-frequency connector 92 (FIG. 6) and an opposing second end (terminal) coupled to B2B connector 102. Phase shifter segment 104 may have a length (e.g., from the first end to the second end) that is selected to impart a selected phase shift to radio-frequency signals conveyed along signal conductor 46 (e.g., such that the radio-frequency signals incident upon phase shifter segment 46 exhibit the selected phase shift by the time the radio-frequency signals leave phase shifter segment 46).

The phase shift imparted by phase shifter segment 104 may perform impedance matching that serves to form a smooth impedance transition from the first portion of signal conductor 46, through B2B connector 102, and to the second portion of signal conductor 46 and antenna 40, thereby serving to optimize the wireless performance of antenna 40. Phase shifter segment 104 may be formed from a conductive trace on a single dielectric layer 108 of printed circuit 88 or may, if desired, be formed from conductive traces on multiple dielectric layers 108 (e.g., conductive traces coupled together by one or more conductive vias extending through dielectric layer(s) 108).

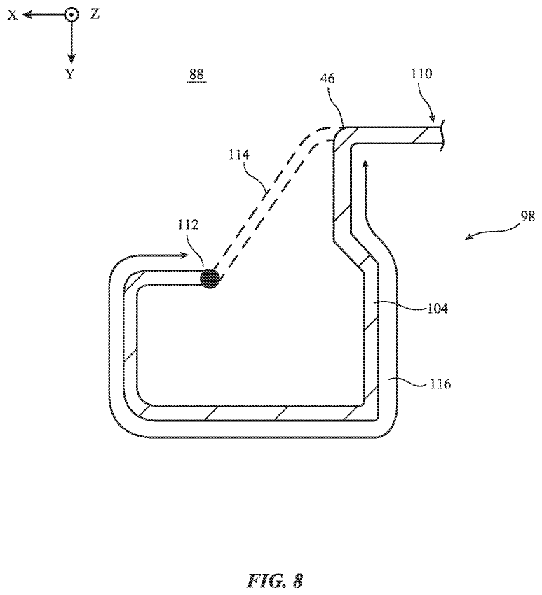

FIG. 8 a top view of phase shifter segment 104 of signal conductor 46. As shown in FIG. 8, phase shifter segment 104 may extend from a first terminal (end) 110 to a second terminal (end) 112. Terminal 110 may be coupled to radio-frequency connector 92 (FIG. 6) whereas terminal 112 is coupled to B2B connector 102 (e.g., over a conductive via extending through one or more dielectric layers of printed circuit 88). Phase shifter segment 104 may follow a meandering or non-linear path having a length 116 that is selected to impart a desired phase shift to radio-frequency signals between terminals 112 and 110 (relative to connecting terminal 110 to terminal 112 via a shortest possible path 114). The phase shift may be selected to configure signal conductor 46 to form a smooth impedance transition from printed circuit 88 to antenna 40 on printed circuit 100 through B2B connector 102 (FIG. 7). If desired, the phase shift may be selected to match a non-ideal (e.g., non-50 Ohm) impedance of an RF front end coupled to signal conductor 46.

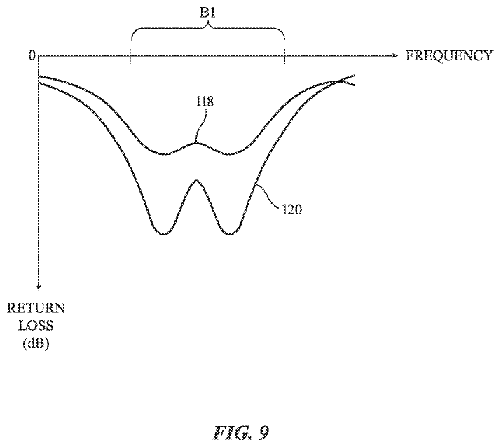

FIG. 9 is a plot of antenna performance (return loss) as a function of frequency for antenna 40 of FIG. 7. In general, lower return losses are indicative of better wireless performance than higher return losses. Curve 118 of FIG. 9 plots the return loss of antenna 40 in the absence of phase shifter segment 104 and other impedance matching structures on signal conductor 46. Curve 120 of FIG. 9 plots the return loss of antenna 40 in the presence of phase shifter segment 104 and other impedance matching structures such as impedance matching transmission line segments on signal conductor 46. As shown by curves 118 and 120, integrating phase shifter segment 104 and the impedance matching structures into signal conductor 46 may serve to boost the response and thus the wireless performance of antenna 40 across frequency band B1 (e.g., a UWB frequency band from 7750 MHz to 8250 MHz). Phase shifter segment 104 and the impedance matching structures may, for example, help to form a smooth impedance transition from printed circuit 88 to antenna 40 on printed circuit 100 that serves to minimize signal reflections at B2B connector 102, thereby minimizing return loss and maximizing antenna efficiency. The example of FIG. 9 is merely illustrative and, in practice, curves 118 and 120 may have other shapes. Frequency band B1 may include any desired frequencies.

The examples of FIGS. 7 and 8 are merely illustrative. Printed circuit 100 of FIG. 7 may have any desired number of antennas 40, each coupled to a different respective signal conductor 46 coupled to B2B connector 102 and radio-frequency connector 92 (FIG. 6). In general, phase shifter segment 104 may have any desired shape having any desired number of curved and/or straight portions. Additionally or alternatively, the impedance matching structures 98 on the first portion of signal conductor 46 (on printed circuit 88) may include one or more open transmission line stubs, one or more grounded transmission line stubs, one or more thicker portions, and/or one or more additional phase shifter segments. If desired, the second portion of signal conductor 46 (on printed circuit 100) may include impedance matching structures 98.

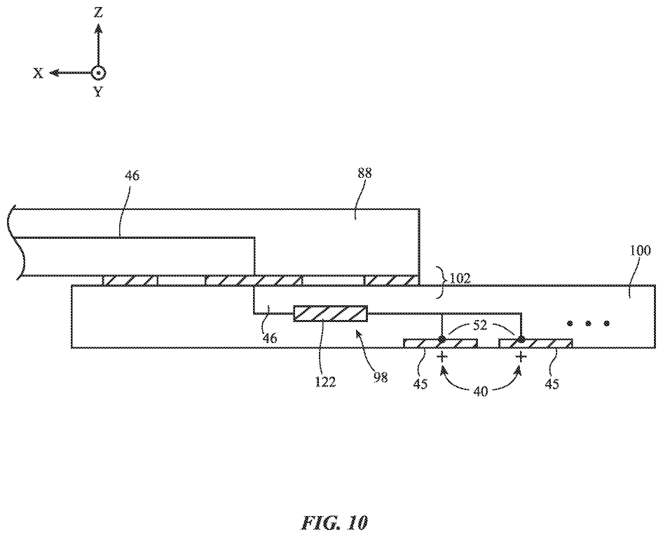

FIG. 10 is a cross-sectional side view of printed circuit 88 and printed circuit 100 at B2B connector 102 showing one example of how a second portion of signal conductor 46 on printed circuit 100 may include impedance matching structures 98 (e.g., as taken along line AA′ of FIG. 6). In general, one or more antennas 40 may be integrated into printed circuit 100. In one implementation that is described herein as an example, printed circuit 100 of FIG. 7 may include a set of two or more (e.g., four) antennas 40 (e.g., arranged in a phased antenna array) that conveys millimeter/centimeter wave signals through opening 80 in ground structures 78 (FIG. 5).

As shown in FIG. 10, the second portion of signal conductor 46 on printed circuit 100 may include impedance matching structures 98. Impedance matching structures 98 may include a segment 122 of signal conductor 46 (e.g., a segment of conductive traces on a dielectric layer of printed circuit 100). Segment 122 may sometimes be referred to herein as matching segment 122. Matching segment 122 may have a different thickness (e.g., in the X-Y plane) than the rest of signal conductor 46 (e.g., matching segment 122 may be thicker than the conductive traces in signal conductor 46 outside of matching segment 122). Matching segment 122 may perform impedance matching that serves to form a smooth impedance transition from the first portion of signal conductor 46, through B2B connector 102, and to antenna 40 through the second portion of signal conductor 46, thereby serving to optimize the wireless performance of antenna 40.

Matching segment 122 may, for example, have a first end (terminal) coupled to B2B connector 102 and an opposing second end (terminal) coupled to a corresponding antenna 40. The thickness of matching segment 122 (e.g., in the X-Y plane orthogonal to the longitudinal axis of the matching segment extending from the first end to the second end) may be selected to form a smooth impedance transition between B2B connector 102 and antenna(s) 40. A single signal conductor 46 may be coupled to the positive antenna feed terminal 52 on multiple antennas 40 in printed circuit 100 or, if desired, each antenna feed terminal 52 on each antenna 40 may be coupled to a different respective signal conductor 46 (e.g., a different respective signal conductor coupled to a different respective signal contact of B2B connector 102). Additionally or alternatively, the impedance matching structures 98 on the second portion of signal conductor 46 (on printed circuit 100) may include one or more open transmission line stubs, one or more grounded transmission line stubs, one or more phase shifter segments, and/or multiple matching segments 122. If desired, both the first portion of signal conductor 46 and the second portion of signal conductor 46 may include impedance matching structures 98 (e.g., the examples of FIG. 7 may be combined such that the first portion of signal conductor 46 includes phase shifter segment 104 and the second portion of signal conductor 46 includes matching segment 122).

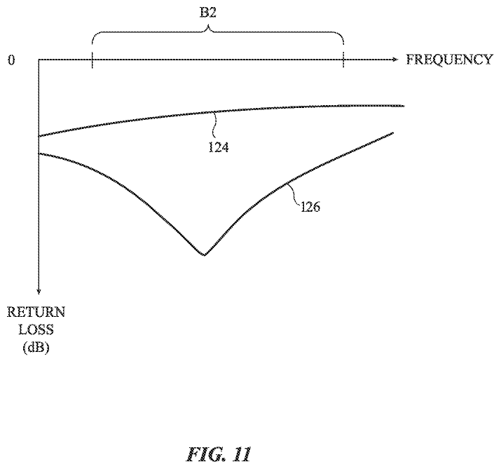

FIG. 11 is a plot of antenna performance (return loss) as a function of frequency for a given antenna 40 of FIG. 10. Curve 124 of FIG. 11 plots the return loss of antenna 40 in the absence of matching segment 122 on signal conductor 46. Curve 126 of FIG. 11 plots the return loss of antenna 40 in the presence of matching segment 122 on signal conductor 46. As shown by curves 124 and 126, integrating matching segment 122 into signal conductor 46 may serve to boost the response and thus the wireless performance of antenna 40 (e.g., by reducing return loss) across frequency band B2 (e.g., a 5G NR FR2 frequency band from 37 GHz to 43 GHz). Matching segment 122 may, for example, help to form a smooth impedance transition from printed circuit 88 to antenna 40 on printed circuit 100 that serves to minimize signal reflections at B2B connector 102, thereby minimizing return loss and maximizing antenna efficiency. The example of FIG. 11 is merely illustrative and, in practice, curves 124 and 126 may have other shapes. Frequency band B2 may include any desired frequencies.

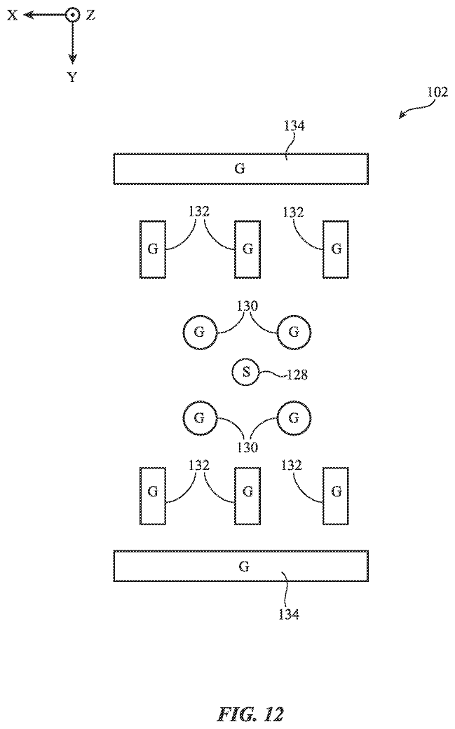

FIG. 12 is a top view showing one example of a B2B connector 102 that may be used to couple printed circuit 88 to printed circuit 100. The B2B connector 102 of FIG. 12 may be used to couple the first portion of signal conductor 46 in printed circuit 88 to the second portion of signal conductor 46 in printed circuit 100 for feeding a single corresponding antenna 40 in printed circuit 100. In one implementation that is described herein as an example, the B2B connector 102 of FIG. 12 may be used to feed a single antenna 40 that conveys UWB signals (e.g., antenna 40 of FIG. 7).

As shown in FIG. 12, B2B connector 102 (sometimes referred to herein as radio-frequency connector 102) may include a set of conductive contacts. The set of conductive contacts in B2B connector 102 may include a signal (S or +) contact 128. Signal contact 128 may include a contact pad on printed circuit 88, a contact pad on printed circuit 100, and solder (e.g., a solder ball) coupled between the contact pads, for example. Signal contact 128 may form a part of the signal conductor 46 for a given antenna 40. For example, the first portion of signal conductor 46 in printed circuit 88 and the second portion of signal conductor 46 in printed circuit 100 may both be coupled to signal contact 128 (e.g., using a first conductive via extending through printed circuit 88 and a second conductive via extending through printed circuit 100).

The set of conductive contacts in B2B connector 102 may also include a set of ground (G or -) contacts 130 adjacent to and laterally surrounding signal contact 128. The set of ground contacts 130 and signal contact 128 may be arranged in a rectangular grid pattern. For example, the set of ground contacts 130 may include a first pair of ground contacts arranged in a first row and first and third columns of the grid, as well as a second pair of ground contacts arranged in a third row and the first and third columns of the grid (e.g., where signal contact 128 is located in the second row and column of the grid). In other words, signal contact 128 may be interposed along a first diagonal axis between the upper-left and bottom-right ground contacts and along a second diagonal axis between the upper-right and bottom-left ground contacts in the set of ground contacts 130 (e.g., where the second diagonal axis is non-parallel or orthogonal to the first diagonal axis).

Each ground contact in the set of ground contacts 130 may include a respective contact pad on printed circuit 88, a respective contact pad on printed circuit 100, and solder (e.g., a solder ball) coupled between the contact pads, for example. Each ground contact in the set of ground contacts 130 may form a part of the ground conductor (e.g., ground conductor 48 of FIG. 3) for the corresponding antenna 40 fed by signal contact 128. For example, each ground contact in the set of ground contacts 130 may be coupled to ground traces (not shown) on one or more layers of printed circuit 88 and/or on one or more layers of printed circuit 100 that form part of the ground conductor. Ground contacts 130 may sometimes be referred to herein as ground pins. Signal contact 128 may sometimes be referred to herein as a signal pin.

The set of conductive contacts in B2B connector 102 may also include a first set of ground bars 132 adjacent to and laterally surrounding two or more sides of the set of ground contacts 130. The first set of ground bars 132 may be arranged in a rectangular grid pattern. For example, the first set of ground bars 132 may include first, second, and third ground bars arranged in a first row and fourth, fifth, and sixth ground bars arranged in a second row (e.g., in three respective columns of ground bars). Ground contacts 130 and signal contact 128 may be laterally interposed between the first and second rows of ground bars 132. The first row of ground contacts 130 may be laterally interposed between signal contact 128 and the first row of ground bars 132. The second row of ground contacts 130 may be laterally interposed between signal contact 128 and the second row of ground bars 132.

The set of conductive contacts in B2B connector 102 may also include a second set of ground bars 134 adjacent to and laterally surrounding two or more sides of the first set of ground bars 132. The second set of ground bars 134 may, for example, include a first ground bar 134 adjacent to the first row of ground bars 132 (e.g., where the first row of ground bars 132 are laterally interposed between the first ground bar 134 and ground contacts 130) and a second ground bar 134 adjacent to the second row of ground bars 132 (e.g., where the second row of ground bars 132 are laterally interposed between the second ground bar 134 and ground contacts 130). Ground bars 132 may be larger than ground contacts 130. Ground bars 132 and 134 may, if desired, have a substantially rectangular (bar) shape. Ground contacts 130 may, if desired, have a circular or rounded shape. Ground bars 134 may be larger (longer) than ground bars 132. Ground bars 134 may laterally extend around two or more (e.g., opposing) sides of B2B connector 102.

Each of ground bars 134 and 132 may include a respective contact pad on printed circuit 88, a respective contact pad on printed circuit 100, and solder (e.g., line or bar of solder) coupled between the contact pads, for example. Each ground bar may be coupled to ground traces (not shown) on one or more layers of printed circuit 88 and/or on one or more layers of printed circuit 100. Ground bars 132 and 134 may sometimes be referred to herein as ground guards or ground contacts. In practice, couplings between rigid and flexible printed circuits can be particularly prone to damage due to external forces such as drop events. Ground bars 132 and 134 may greatly increase the soldered area of B2B connector 102, thereby maximizing the mechanical strength of B2B connector 102 and the coupling between printed circuits 88 and 100, preventing the printed circuits from becoming separated and/or deteriorating antenna performance even as device 10 is subject to external forces such as drop events during its lifetime. Holding ground bars 132 and 134 at a ground potential may prevent the ground bars from interfering with radio-frequency signals conveyed over signal contacts 128 and ground contacts 130 while also helping to shield the radio-frequency signals from interference from other components.

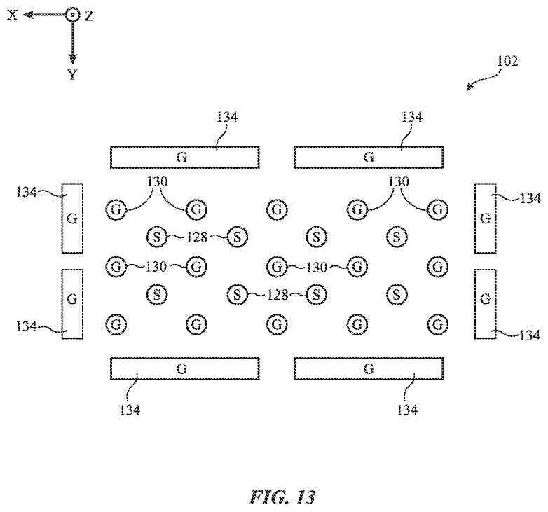

The example of FIG. 12 is merely illustrative. The set of conductive contacts in B2B connector 102 may be arranged in any desired pattern. FIG. 13 is a top view showing another example of a B2B connector 102 that may be used to couple printed circuit 88 to printed circuit 100. In one implementation that is described herein as an example, the B2B connector 102 of FIG. 13 may be used to feed a set of antennas 40 on printed circuit 100 that conveys millimeter/centimeter wave signals (e.g., antennas 40 of FIG. 10). In this example, the set of antennas 40 includes eight antennas 40 each having a single positive antenna feed terminal or includes four antennas 40 each having two positive antenna feed terminals (e.g., for conveying radio-frequency signals with two orthogonal polarizations).

As shown in FIG. 13, B2B connector 102 may include a set of signal contacts 128 (e.g., eight signal contacts 128). Each signal contact 128 may have a respective set of ground contacts 130 adjacent to and laterally surrounding that signal contact 128 (e.g., each signal contact 128 may have four ground contacts 130 surrounding the signal contact in the same rectangular pattern shown in FIG. 12). Each signal contact 128 may form a part of a respective signal conductor 46 for a given antenna 40 in printed circuit 100 (e.g., where each signal conductor is coupled to a different respective positive antenna feed terminal in the set of antennas 40 on printed circuit 100).

In other words, signal contacts 128 may be laterally interleaved or interspersed with ground contacts 130 in B2B connector 102. B2B connector 102 may, for example, include a first row of ground contacts 130, a second row of signal contacts 128 that are laterally offset (e.g., along the X-axis) from the ground contacts 130 in the first row, a third row of ground contacts 130 that are laterally offset (e.g., along the X-axis) from the signal contacts 128 in the second row but that are laterally aligned (e.g., along the X-axis) with the ground contacts 130 in the first row, a fourth row of signal contacts 128 that are laterally offset (e.g., along the X-axis) from the ground contacts 130 in the third row but that are laterally aligned (e.g., along the X-axis) with the signal contacts 128 in the second row, and a fifth row of ground contacts 130 that are laterally offset (e.g., along the X-axis) from the signal contacts 128 in the fourth row but that are laterally aligned (e.g., along the X-axis) with the ground contacts 130 in the first and third rows. This checkerboard or interleaved pattern of signal contacts 128 and ground contacts 130 may, for example, be the most space-efficient layout for allowing B2B connector 102 to pass eight signal conductors for eight different positive antenna feed terminals between printed circuits 88 and 100.

As shown in FIG. 13, the set of conductive contacts in B2B connector 102 may also include a second set of ground bars 134 adjacent to and laterally surrounding two or more sides (e.g., all four sides) of the ground contacts 130 and signal contacts 128 in B2B connector 102. B2B connector 102 may, for example, include first and second ground bars 134 extending along a first (left) side of B2B connector 102, third and fourth ground bars 134 extending along a second (top) side of B2B connector 102, fifth and sixth ground bars 134 extending along a third (right) side of B2B connector 102, and seventh and eighth ground bars 134 extending along a fourth (bottom) side of B2B connector 102. Ground bars 134 may serve to maximize the mechanical strength of B2B connector 102 and the coupling between printed circuits 88 and 100, thereby the printed circuits from becoming separated and/or deteriorating antenna performance even as device 10 is subject to external forces such as drop events during its lifetime.

Device 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made by those skilled in the art without departing from the scope and spirit of the described embodiments. The foregoing embodiments may be implemented individually or in any combination.

What is claimed is:

1. An electronic device comprising:
peripheral conductive housing structures;
a first antenna having an antenna resonating element formed from a segment of the peripheral conductive housing structures;
a first printed circuit;
a first signal conductor on the first printed circuit and coupled to the segment of the peripheral conductive housing structures;
a second printed circuit;
a second antenna on the second printed circuit;
a board-to-board (B2B) connector that couples the first printed circuit to the second printed circuit; and
a second signal conductor that extends from the first printed circuit, through the B2B connector, and to the second antenna, wherein the second signal conductor comprises an impedance matching segment on the second printed circuit between the B2B connector and the second antenna.

2. The electronic device of claim 1, wherein the first printed circuit comprises a flexible printed circuit board.

3. The electronic device of claim 2, wherein the second printed circuit comprises a rigid printed circuit board.

4. The electronic device of claim 1, wherein the second signal conductor has a portion on the first printed circuit, the impedance matching segment being thicker than the portion on the first printed circuit.

5. The electronic device of claim 4, further comprising:
a phased antenna array on the second printed circuit and configured to convey radio-frequency signals at a frequency greater than 10 GHz, the phased antenna array including the second antenna.

6. The electronic device of claim 1, wherein the B2B connector comprises:
a signal contact that forms part of the second signal conductor, the impedance matching segment being coupled between the signal contact and a positive antenna feed terminal of the second antenna.

7. The electronic device of claim 6, wherein the B2B connector further comprises:
four ground contacts laterally surrounding the signal contact.

8. The electronic device of claim 7, wherein the B2B connector further comprises:
a set of ground bars laterally surrounding the four ground contacts.

9. The electronic device of claim 1, wherein the B2B connector comprises:
a first row of ground contacts;
a second row of signal contacts laterally offset from the ground contacts in the first row;
a third row of ground contacts laterally offset from the signal contacts in the second row and aligned with the ground contacts in the first row;
a fourth row of signal contacts laterally offset from the ground contacts in the third row and aligned with the signal contacts in the second row; and
a fifth row of ground contacts laterally offset from the signal contacts in the fourth row and aligned with the ground contacts in the first and third rows, wherein the impedance matching segment is coupled between one of the signal contacts in the second row and a feed terminal on the second antenna.

10. The electronic device of claim 9, wherein the B2B connector further comprises:
first and second ground bars, wherein the first row of ground contacts is laterally interposed between the second row of signal contacts and the first and second ground bars; and
third and fourth ground bars, wherein the fifth row of ground contacts is laterally interposed between the fourth row of signal contacts and the third and fourth ground bars.

11. The electronic device of claim 10, wherein the B2B connector further comprises:
fifth and sixth ground bars that extend from the first ground bar to the third ground bar at a first side of the B2B connector; and
seventh and eight ground bars that extend from the second ground bar to the fourth ground bar at a second side of the B2B connector opposite the first side.

12. An electronic device comprising:
a first printed circuit;
a second printed circuit;
a board-to-board (B2B) connector that couples the first printed circuit to the second printed circuit;
an antenna resonating element on the second printed circuit; and
a signal conductor, wherein the signal conductor has a first portion on the first printed circuit and coupled to a signal contact of the B2B connector, the signal conductor has a second portion on the second printed circuit and coupled between the signal contact of the B2B connector and the antenna resonating element, and the first portion of the signal conductor comprises a phase shifter segment coupled to the B2B connector.

13. The electronic device of claim 12, wherein the first printed circuit is a flexible printed circuit board.

14. The electronic device of claim 13, wherein the second printed circuit is a rigid printed circuit board.

15. The electronic device of claim 14, further comprising:
a dielectric cover layer;
a conductive layer on the dielectric cover layer; and
an opening in the conductive layer, wherein the antenna resonating element is configured to convey ultra-wideband (UWB) signals through the opening.

16. The electronic device of claim 12, wherein the B2B connector comprises:
first, second, third, and fourth ground contacts, wherein the first ground contact, the signal contact, and the fourth ground contact are aligned along a first axis and wherein the second ground contact, the signal contact, and the third ground contact are aligned along a second axis that is non-parallel with respect to the first axis.

17. The electronic device of claim 16, further comprising:
a first row of ground bars, wherein the first and second ground contacts are laterally interposed between the first row of ground bars and the signal contact; and
a second row of ground bars, wherein the third and fourth ground contacts are laterally interposed between the second row of ground bars and the signal contact.

18. The electronic device of claim 17, further comprising:
a first ground bar, the first row of ground bars being laterally interposed between the first and second ground contacts and the first ground bar; and
a second ground bar, the second row of ground bars being laterally interposed between the third and fourth ground contacts and the second ground bar, wherein the first ground bar and the second ground bar are longer than each ground bar in the first row of ground bars and each ground bar in the second row of ground bars.

19. Apparatus comprising:
a flexible printed circuit;
a rigid printed circuit; and
a radio-frequency board-to-board (B2B) connector that couples the flexible printed circuit to the rigid printed circuit, the radio-frequency B2B connector comprising:
a set of signal contacts,
a set of ground contacts interleaved with the set of signal contacts, and
a set of ground bars laterally surrounding the set of signal contacts and the set of ground contacts.

20. The apparatus of claim 19, wherein the set of signal contacts comprise a first set of contact pads on the flexible printed circuit, a second set of contact pads on the rigid printed circuit, and a first set of solder balls between the first and second sets of contact pads, the set of ground contacts comprise a third set of contact pads on the flexible printed circuit, a fourth set of contact pads on the rigid printed circuit, and a second set of solder balls between the third and fourth sets of contact pads, and the set of ground bars comprise a fifth set of contact pads on the flexible printed circuit, a sixth set of contact pads on the rigid printed circuit, and lines of solder between the fifth and sixth sets of contact pads.
